(19) United States
(12) Patent Application Publication
(10) Pub. No.: US 2012/0017584 A1
(43) Pub. Date: Jan. 26, 2012

(54) CRYONUCLEATOR

(76) Inventor: Dennis Sheanne Hudson, Albuquerque, NM (US)

(21) Appl. No.: 12/841,168

(22) Filed: Jul. 21, 2010

(51) Int. Cl. F03G 7/06

(52) U.S. Cl. 60/530

(57) ABSTRACT

A device (FIG. 8b) for generating energy using the expansive force of freezing water with an adjuvant to lower its freezepoint; a device (FIG. 12b) for generating energy using the expansive force of freezing water with or without an adjuvant to lower its freezepoint, and; an aerospace device (FIG. 19c) for generating energy using the expansive force of freezing water with or without an adjuvant to lower its freeze point, with cyclic rate enhanced by solar radiation and the heat sink of shaded interplanetary space; in all embodiments, an hydraulic pump.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

The cryonucleator relates principally to the generation and releasable storage of mechanical energy as initially generated by the freezing expansion of water with and without a freezepoint lowering adjuvant. The energy is proximally transmitted to a fluid medium for conversion into other forms of energy and the releasable storage of such other forms; it is therefore in part an hydraulic pump. It further refers to use of the cryonucleator as a teaching device, research device, and as integral with a building. Generally, ambient naturally occurring temperature conditions drive the phase change cycle, though artificial heat sinks and sources may also be used in some embodiments.

2. Prior Art

In satellites, ion-drive engines rely on massive amounts of electrical power to eject a small ion stream at high speed in order to provide propulsion. The thermal energy for this is provided by a small nuclear reactor, and converted to electrical energy which is stored in capacitors for until needed. This system imposes large mass and cost burdens on launch projects, thereby reducing payload. It also poses serious environmental hazards because the reactors eventually fail and satellites then fall to earth, sometimes with disastrous and very costly consequences, as happened in western Canada when a Russian ion-drive satellite crashed there in the 1970s, scattering radioactive debris over a wide area.

As to the prior art of energy production in general, the main sources have been coal, petroleum products, hydroelectric power, and nuclear energy, all of which impose heavy burdens of cost and environmental damage. Lesser sources have been solar, wind, geothermal, and wave energy, none of these yet having become sufficiently cost effective to enjoy universal use.

The lack of viable energy alternatives also presents national security concerns, the common view being that the approximately $1 trillion spent annually on oil imports may be in part funding the activities of parties hostile to this country's national interests.

### OBJECTS AND ADVANTAGES

Thus, objects and advantages of the present invention include:

(a) in chief, provision of high cyclic rates, or freeze to thaw rates, through addition of a freezepoint lowering adjuvant to the water;

(b) the provision of massive amounts of cheap, renewable, non-polluting, environmentally safe mechanical energy which may be readily converted to other energy forms, including electrical energy and hydrogen; raw hydraulic energy can be used to operate heavy equipment at construction sites or loading docks, to operate railway systems, or raw hydraulic output from small cryonucleators may be used to operate snowmobiles or other snowcraft;

(c) the reduction of reliance on petroproduct and nuclear energy forms, with an according reduction in pollution, cost, and global conflict;

(d) the provision of cheaper, safer power systems for spacecraft;

(e) the provision of clean cheap power to ships and other marine conveyances in port and at sea;

(f) the provision of clean, cheap power to arctic and antarctic civil and scientific communities, avoiding the environmental damage caused by use of petrofuels;

(g) reduced reliance on chemical batteries in automotive applications, increased lifespan of such batteries, and reduction in pollution associated with the manufacture and disposal of such batteries;

(h) increased economic growth due to cheaper energy costs, enabling useful processes and activities which heretofore were prohibited by high energy costs, and massively increased manufacturing activity, particularly in steel and ceramics, with according increases in employment;

(i) greatly extended infrastructure lifespan compared to the prior art in energy production systems, since all aspects of the cryonucleator have few moving parts;

(j) elimination of the need to gather and maintain fuel stockpiles at great cost for energy production;

(k) the provision of a device to cheaply produce hydrogen, and to enable the United States to become fully energy independent and a net exporter of hydrogen;

(l) the provision of a device to teach the principles of math, chemistry, and physics to students and others, and a convenient device for facilitating the conduct of desktop high pressure research;

(m) reduction in the use of corn and other edible grains to produce ethanol, which will help to increase the supply of and reduce the cost of these edible commodities, and;

(n) the provision of a device to separate frozen water from an adjuvant.

The charts of FIGS. 30A through 30D, inclusive, are instructive in illustrating several of the objects and advantages mentioned above. These show, respectively: work available from each cubic foot of freezing water at various temperatures; a 1000 cubic foot residential reactor's output at various temperatures; and a schematic of a large cryonucleator installation. Charts are based in part on data from Handbook of Chemistry and Physics, published by Chemical Rubber Company, 36th Edition, “Melting Point of Ice-Variation with Pressure”, per Tamann, page 2114. However, the inventor admits to some uncertainty about cryonucleator operation under certain conditions, as in academic circles there seems to be uncertainty as to the phase of water at pressure in the range of 28,000 psi when at −20 C (−4 F): it may be solid or liquid. This, however, would not seem to affect cryonucleator outputs stated in this application, since such low temperature values are not used for those calculations and since, in any case, upon release of confining pressure the water charge will expand its full 10 percent. Moreover, in the extraterrestrial embodiment of the cryonucleator, though much lower temperatures can be expected, it is doubtful, given present technology and mass considerations, that anyone would construct and launch a reactor designed to withstand more than 20,000 psi. Still, the above uncertainty must be considered for any reactor intended for higher pressures at 20 C (−4 F); some mechanical adaptation of the present invention may be needed.

FIG. 30C makes the assumption that a locality experiencing seasonal freezing temperatures will also experience a daily temperature variance of an average −9.4 C (15 F), a daily low of −6.1 C (21 F) or less, and only two daily temperature retreats and advances, or cycles, across a single range of −6.1 C (21 F) to −2.2 C (28 F). Energy capture, or freezepoint, is set with adjuvant at −5 C (23 F).

In January, 2009, Topeka, Kans., for example, had a daily variance of about −7.8 C (18 F), with a daily low always below 0 C (32 F) and a daily high always above 0 C (32 F); average daily high was about 3.3 C (38 F), and average daily low was about −7.8 C (18 F). The chart's assumptions are therefore quite modest, considering that many localities have much lower daily lows than −3.9 C (25 F), resulting in more available power, and very frequent hourly advances and retreats in temperature, resulting in higher cyclic rates with an adjuvant.

FIG. 30C also relies on the U.S. Department of Energy figures for 2008. These data indicate that in 2008 about 2.7 trillion kWh (kilowatt hours) of electricity were consumed in the United States by the residential and commercial sectors combined. To simplify, each cubic foot of water freezing at −5 C (23 F) yields 0.05388076368 kWh. Since we assume two daily cycles, that figure is doubled to 0.10776152736 kWh per cubic foot per day. We have about 90 days per year of freezing temperatures, and multiplying that output by 90, we have an output of 9.6985374624 kWh per cubic foot of water per season. Dividing our needs of 2.7 trillion kWh by that number means that we need to cycle about 7 billion cubic meters (278 billion cubic feet) of water per year in this fashion, a seemingly large number but quite manageable, as follows.

We have about 25 cold northern states across which to deploy such a system. In round numbers, deploying about 311.5 million cubic meters (11 billion cubic feet) in each would do the job of meeting our annual electrical needs. That translates to a cube about 2,224 feet on a side, or 0.42 miles per side, an inconvenient geometry which works better as a rectilinear solid roughly 50 feet high by 2.8 miles (14,832 feet) per side. Some or all of this could be deployed underground, with heat exchangers above ground. Of course, this volume would not be contained in a single reactor but in many smaller reactors, and we must allow workspace and heat exchanger space, so let us triple the size to accommodate the needed water per state plus workspace and equipment, e.g., to an installation roughly 5 miles per side and 50 feet in height, as illustrated by FIG. 30D. One of these in each of the 25 cold states would power the entire nation. The implementation of this system would provide full employment, and a massive boost to the steel, concrete, heavy equipment, and construction industries, all of which would also be engaged in developing hydraulic or hydrogen pipeline networks to other states. Power storage can be handled in a variety of ways.

The project would exceed in scope that of the WPA of the 1930s and at the end of it the nation would meet all of its commercial and residential electrical power needs; to cover additional needs for heating would require roughly a doubling or trebling of the system, still a manageable feat which would make the United States completely energy independent. Any further extension would render the country a net hydrogen exporter.

### SUMMARY

As accords with the present invention, the cryonucleator comprises a sealable enclosure, i.e., reactor, for containing a freezable liquid which expands upon freezing, heat exchanger, a drive fluid placed within the reactor, and an output valve for permitting the pressurized drive fluid, driven by the freezing expansion of the freezable liquid, to flow to a place where it may proximally generate electricity or perform other useful work; and further, the cryonucleator for extraterrestrial use, comprises a sealable enclosure for containing a freezable liquid which expands upon freezing, heat exchanger, a drive fluid, an output port for permitting the pressurized drive fluid, driven by the freezing water, to flow to a place where it may proximally generate electricity or perform other useful work, the freezable liquid within the enclosure, together with the drive fluid and other parts arranged in a way that creates a closed system with substantially no gas pockets or uncontrolled partial vacuums; the cryonucleator for use in an extraterrestrial environment, or extraterrestrial cryonucleator, adds shields to control whether substantially warming light reaches parts of the heat exchanger when desirable, mechanical devices to ensure hydraulic force integrity, and in one embodiment adds a mechanical energy storage system.

### DRAWINGS, FIGURES

Drawing figures are numbered according to their related claims, e.g., FIG. 2B refers to Claim 2.

Drawings relating to Claims 1-10, inclusive, are as follows:

FIG. 1A shows an exterior view of the reactor.

FIG. 1B shows a sectional view of the reactor with drive fluid and freezable liquid.

FIG. 2A shows an exterior view of the reactor and storage device.

FIG. 3A shows an exterior view of the reactor with the generator.

FIG. 3B shows a sectional view of the reactor, generator, drive fluid, and freezable liquid.

FIG. 4A shows an exterior view of the reactor with generator and electrolysis.

FIG. 4B shows a sectional view of the reactor, generator, electrolysis, drive fluid, and freezable liquid.

FIG. 5A shows a sectional view of the reactor, exterior of the sealable container, drive fluid, and freezable liquid.

FIG. 5B shows an exterior view of the sealable container.

FIG. 5C shows a sectional view of the sealable container, rigid cylinder, piston, and resilient member.

FIG. 6A shows the float, pulley, winch, and part of the reactor.

FIG. 7A shows the exterior of the reactor with heat exchange unit.

FIG. 7B shows a sectional view of heat exchange unit, reactor, drive fluid, and freezable liquid.

FIG. 8A shows an exterior view of the reactor.

FIG. 8B shows a sectional view of the reactor and its contents.

FIG. 9A shows an exterior view of the heat exchange unit, reactor, and controller.

FIG. 9B shows a sectional view of the heat exchange unit, reactor and contents.

FIG. 10A shows an exterior view of the reactor, generator, and hydraulic lift.

Drawings relating to Claims 11-17, inclusive, are as follows:

FIG. 11A shows an exterior view of reactor.

FIG. 11B shows a sectional view of reactor and its contents.

FIG. 12A shows an exterior view of reactor and hatch.

FIG. 12B shows a sectional view of reactor and its contents.

FIG. 13A shows an exterior view of the buoy and its elements.

FIG. 13B shows a sectional view of the buoy and its elements.

FIG. 14A shows a sectional view of teaching device reactor and its contents.

FIG. 14B shows an exterior view of generator.

FIG. 14C shows an exterior view of electric light.

FIG. 14D shows an exterior view of assorted die stamping parts.

FIG. 14E shows a sectional view of a compression device.

FIG. 15A shows an exterior view of a marine conveyance, in this instance a ship, with heat exchange units.

FIG. 15B shows a sectional view of aft part of marine conveyance, looking towards bow, with sectional view of reactor and other elements.

FIG. 15C shows a lateral view of storage unit, with sectional views of reactor, reservoir, and other elements.

FIG. 15D shows a sectional view of reactor with retainer in place.

FIG. 16A shows an exterior view of reactor, heat exchange unit, reservoir, and controller.

FIG. 16B shows a sectional view of reactor, its contents, and other elements in sectional view.

FIG. 17A shows an exterior view of an architectural structure, or building, and a bench as an appurtenance thereof in the form of a heat exchange unit, together with reactor and an additional heat exchange unit as part of the wall of the structural unit.

Drawings relating to Claims 18-19, inclusive, are as follows:

FIG. 18A shows an exterior view of reactor, shield in two positions, heat exchange unit, reservoir, generator, controller, and sensor.

FIG. 18B shows a sectional view of reactor, enclosure, containment device, freezable liquid, and drive fluid.

FIG. 18C shows an exterior view of reactor, reservoir, and generator.

FIG. 18D shows an exterior view of generator.

FIG. 18E shows a cutaway view of generator and its openings.

FIG. 18F shows an exterior view of reservoir.

FIG. 18G shows a cutaway view of reservoir and its openings.

FIG. 19A shows an exterior view of reactor with reservoir, generator, and storage unit.

FIG. 19B shows a schematic view of valve with adaptation.

FIG. 19C shows a sectional view of reactor, retainer, and containment unit.

Drawings relating to charts are as follows:

FIG. 30A shows a chart of pressure and work potential of freezing water.

FIG. 30B shows a chart of kWh output of freezing water in a 1000 cubic foot unit.

FIG. 30C shows a chart of reactor distribution and kWh output across 25 states.

FIG. 30D shows a side view schematic of a large cryonucleator installation.

FIG. 30E shows a cutaway top view schematic of a large cryonucleator installation.

### REFERENCE NUMERALS AND TERMS

Drawing reference numerals are numbered according to their related claims times 100, e.g., 100-3a refers to Claim 1, 1800-2b refers to claim 18, etcetera. The number following the hyphen refers to the paragraph within the claim, e.g., 100-3a refers to the third paragraph of Claim 1. Where an additional limitation of an independent claim occurs in the preamble of one of its dependent claims, only a letter suffix is assigned to designate it, e.g., 1200-a recited in the preamble of claim 12 refers to a limiting feature of a valve from independent claim 11. In most cases, the alphabetical suffix relates to the order in which the element is recited in the claim, e.g., 100-3a refers to drive fluid, which is the first element mentioned in the third paragraph, or paragraph [c], of Claim 1. Drawing reference numerals are as follows:
100-1a reactor; 100-1b first opening into reactor; 100-2a freezable liquid; 100-3a drive fluid; 100-4a first valve;
200-a first branch of valve of 100-4a; 200-b second branch of valve of 100-4a; 200-1a storage unit; 200-1b opening into storage unit;
300-1a generator; 300-1b fluid intake port of generator; 400-1a generator; 400-1b fluid intake port of generator; 400-2a electrical conduit; 400-3a water electrolysis unit;
500-1a flexible, sealable container; 500-2a rigid cylinder; 500-3a piston; 500-4a resilient member;
600-1a winch; 600-1b fluid intake port of winch; 600-2a cable; 600-2b proximal end of cable; 600-3a pulley; 600-4a anchor; 600-4b attachment of anchor to pulley; 600-5a float;
700-1a second opening into reactor; 700-2a heat exchange unit;
800-1a containment device; 800-2a second opening into reactor; 800-3a first opening into containment device; 800-4a filter; 800-5a second valve; 800-6a retainer; 800-7a third opening into reactor; 800-8a second opening into containment device; 800-9a third valve; 800-10a duct; 800-10b one of a plurality of openings into duct; 800-10c opening of duct coupled to third valve;
900-1a enclosure; 900-1b first opening of enclosure; 900-1c second opening of enclosure; 900-2a containment device; 900-3a second opening into reactor; 900-4a heat exchange unit; 900-5a valve of enclosure; 900-6a controller;
1000-1a adapter for first valve of reactor; 1000-2a hydraulic lift; 1000-2b load; 1000-3a generator; 1000-3b fluid intake port of generator;
1100-1a reactor; 1100-b first opening into reactor; 1100-2a freezable liquid; 1100-3a drive fluid; 1100-4a first valve of reactor;
1200-a pressure relief adaptation; 1200-1a second opening into reactor; 1200-2a hatch; 1200-3a containment device; 1200-3b opening into containment device; 1200-4a third opening into reactor; 1200-5a second valve; 1200-6a piston; 1200-6b attachment of piston to containment device; 1200-6c opening in piston;
1300-1a second opening into reactor; 1300-2a first heat exchange unit; 1300-3a third opening into reactor; 1300-4a second heat exchange unit; 1300-5a support unit; 1300-6a fourth opening into reactor; 1300-6b fifth opening into reactor; 1300-7a second valve; 1300-8a reservoir; 1300-9a valve adapter; 1300-10a first storage unit; 1300-10b first opening of first storage unit; 1300-10c second opening of first storage unit; 1300-11a second storage unit; 1300-11b first opening of second storage unit; 1300-11c second opening of second storage unit; 1300-12a generator; 1300-12b fluid output port of generator; 1300-12c fluid intake port of generator; 1300-13a third valve; 1300-14a electrical conduit; 1300-15a beacon; 1300-16a containment unit; 1300-17a retainer; 1300-18a controller; 1300-18b sensor of controller; 1300-19a attachment device;
1400-1a deformable container; 1400-2a retainer; 1400-3a storage unit; 1400-4a generator; 1400-4b hydraulic fluid intake port of generator; 1400-4c hydraulic fluid output port of generator; 1400-4d hydraulic fluid intake duct for generator; 1400-4e hydraulic fluid output duct for generator; 1400-4f negative terminal of generator; 1400-4g positive terminal of generator; 1400-4h light; 1400-4i an electrical terminal of light; 1400-4j an electrical terminal of light; 1400-4k compression device; 1400-4l hydraulic fluid duct into compression device; 1400-4m threaded removable part of compression device; 1400-4n threaded removable part of compression device; 1400-4o piston of compression device; 1400-4p sample of substance capable of being transformed by high pressure, loaded into compression device; 1400-4q resilient backing disc; 1400-4r die stamping part; 1400-4s die stamping part;
1500-1a marine conveyance; 1500-2a second opening into reactor; 1500-3a first heat exchange unit; 1500-3b a part of first heat exchange unit; 1500-3c a part of first heat exchange unit; 1500-4a third opening into reactor; 1500-5a second heat exchange unit; 1500-5b a part of second heat exchange unit; 1500-5c a part of second heat exchange unit; 1500-6a containment device; 1500-7a duct; 1500-7b first opening of duct; 1500-7c second opening of duct; 1500-8a second valve; 1500-9a storage device; 1500-9b opening into storage device; 1500-10a retainer; 1500-11a fourth opening into reactor; 1500-12a third valve; 1500-13a reservoir; 1500-13b first opening into reservoir; 1500-13c second opening into reservoir;
1600-1a second opening into reactor; 1600-2a second valve; 1600-3a reservoir; 1600-3b first opening of reservoir; 1600-3c second opening of reservoir; 1600-4a third opening into reactor; 1600-5a heat exchange unit; 1600-5b heat source, shown as a muffler; 1600-6a storage device; 1600-7a controller; 1600-8a containment device; 1600-9a retainer;
1700-a structural shelter and appurtenance; 1700-b second opening into reactor; 1700-1a heat exchange unit;
1800-1a reactor; 1800-2a enclosure; 1800-2b attachment of enclosure to reactor; 1800-3a first opening into enclosure; 1800-4a valve of enclosure; 1800-5a containment device; 1800-6a freezable liquid; 1800-7a drive fluid; 1800-8a second opening into enclosure; 1800-9a first opening into reactor; 1800-10a heat exchange unit; 1800-11a shield; 1800-11b attachment of shield to reactor; 1800-11c shield in position to block radiant starlight energy from reaching heat exchange unit; 1800-12a second opening into reactor; 1800-13a reservoir; 1800-13b attachment of reservoir to reactor; 1800-13c first opening of reservoir; 1800-13d second opening of reservoir; 1800-14a third opening into reactor; 1800-15a generator; 1800-15b attachment of generator to reactor; 1800-15c hydraulic fluid intake port of generator; 1800-15d hydraulic fluid output port of generator; 1800-16a second valve, coupling first opening of reservoir and second opening of reactor; 1800-17a third valve, coupling third opening of reactor and intake port of generator; 1800-18a fourth valve, coupling generator output port and second opening of reservoir; 1800-19a controller; 1800-19b attachment of controller to reactor; 1800-20a fourth opening into reactor; 1800-21a third opening into enclosure; 1800-22a third opening into reservoir; 1800-23a sensor; 1800-23b attachment of sensor to reactor; 1800-23c part of a plurality of sensor nodes; 1800-23d sensor communication with controller;
1900-a adaptation of third valve [1800-17a]; 1900-1a storage device; 1900-1b opening of storage device; 1900-2a retainer, and; 1900-2b adaptation of retainer, shown as an opening;
3000-a schematic region of reactors, service areas, catwalks, heat exchangers, storage units; 3000-b schematic region of rooftop heat exchangers; 3000-c schematic array of reactors, heat exchangers, storage units; 3000-d schematic array of catwalks, service areas.

In part for the convenience of the public, and not by way of limiting interpretation of the appended claims and drawings, the following terms have the meanings stated below, in addition to any equivalents thereof permitted by law, rule, or equity, and in addition to their plain meaning and context within the claims, but all according to their limitations as stated in the claims, and all only as presently known or as would be obvious in the arts to which the terms pertain: an adapter refers to a device integral with a valve to enable fluidic communication between any combination of two or more destinations; adjuvant refers to substance which, when combined with water, may reduce the freezing point of water; anchor refers to a mass having negative buoyancy in water or to a line or cord proximally attached to the bed of a water body; an appurtenance of an architectural structure refers to objects peripheral to a building, including, but not limited to, walkways, driveways, parking areas, statuary, benches, monuments, and walls not integral with a building per se; an architectural structure has its common meaning; a beacon is as stated in the claims; cable has its common meaning and may also include ropes of wire or plastic, or chains of metal; combustion engine has its common meaning, and includes but is not limited to engines operating on gasoline, diesel, propane, ethanol, methane, or hydrogen; communication has its common meaning, either directly or wirelessly; a containment element refers to a deformable and substantially nonpermeable construct which may readily deform in response to applied fluidic pressure, and includes but is not limited to constructs of flexible plastic, and sealed constructs of rigid materials adapted to collapse and expand; a controller refers to a device which may control the position or state of a valve or electrical switch or other switching mechanism and, according to its context within a claim, may directly or remotely do so, or may be programmed to do so according to an algorithm established by an operator; a cylinder has its common meaning but may be of cross sectional shape other than round, and is constructed of a rigid material; a deformable backing disc refers to an elastically or plastically deformable disc which may be of rubber, plastic, wood, or other material; a die stamping part has its common meaning; a drive fluid is any liquid capable of transmitting hydraulic force; a duct has its common meaning, and is constructed of a substantially nonpermeable material; an elastically deformable element may be a gas or spring; electrical conduit refers to wiring or other devices to transmit electricity; electrolysis refers to electrical systems for separating water into its molecular components; an enclosure has its common meaning and is constructed of a substantially rigid and nonpermeable material; a filter has its common meaning and further includes any construct or trap intended to substantially restrain the movement of solid particles past the filter while permitting the movement of a liquid past it; a flexible sealable container refers to a construct of substantially nonpermeable material such as plastic, rubber, latex, or similarly flexible material; a float refers to an object having positive buoyancy in water; a freezable liquid has its common meaning; a generator refers to electrical generators; a hatch refers to an openable or removable cover; a heat exchange element has its common meaning, including, but not limited to, a sealed duct containing a fluid, or solid object readily capable of transmitting heat; an hydraulic lift has its common meaning; an hydraulically driven compression device is one employing hydraulic force to drive a ram against an object in order to subject it to pressure; a marine conveyance refers to, but is not limited to, a ship, raft, boat, submergeable watercraft, or platform located in or upon or adjacent to a body of water; opening has its common meaning; piston has its common meaning but may be of cross sectional shape other than round, and is constructed of a rigid material; pressure relief adaptation is a valve to relieve accumulated air pressure or excess water pressure; pulley has its common meaning; reactor is a sealable enclosure, constructed of any rigid and substantially nonpermeable material; a reservoir has its common meaning and also refers to a vessel for containing drive fluid, and in the case of the extraterrestrial embodiment, incorporates a pump or resilient member to facilitate hydraulic integrity in low gravity; resilient member is as stated in the claims; a retainer has its common meaning and includes but is not limited to a construct attached to or at least partially surrounding another object in order to restrict its movement relative to the retainer or relative to some third object; self locking has reference to devices for preventing a secondary device from moving to a previous position; a sensor has its common meaning and includes but is not limited to any device which may respond to pressure, heat, light, or an electrical field by generating a transmissible signal; a shield refers to an apparatus for substantially blocking light and includes but is not limited to an arrangement of blinds or substantially opaque or highly reflective materials, or a substance having a high degree of infrared absorption; storage, in the claims, refers to a structure for storing mechanical energy; a support element refers to an object having positive buoyancy in water, or which may act to substantially maintain a further object in a desired position in a water body; a valve has its common meaning, and; winch has its common meaning.

### DETAILED DESCRIPTION

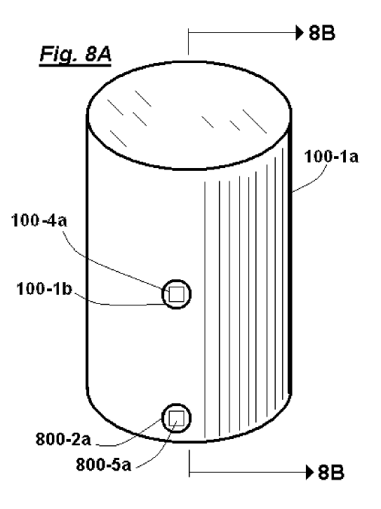

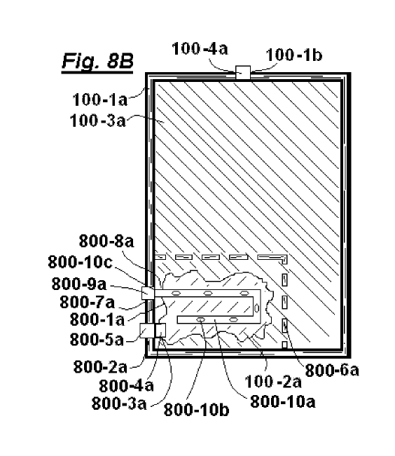

### FIGS. 8B, 12B, and 19C—Preferred Embodiments of Independent Claims 1, 11, and 18, Respectively

A preferred embodiment of the device of independent claim 1, or cryonucleator using a freezable liquid having a freezing point less than 32 F, is presented in FIG. 8B, which is a sectional view of FIG. 8A. Shown is a reactor 100-1a, or tank, having a valve 100-4a seated in reactor opening 100-1b, a valve 800-9a seated in reactor opening 800-7a, and a valve 800-5a seated in reactor opening 800-2a, with the reactor further containing: a drive fluid 100-3a; a containment device 800-1a having a filter 800-4a seated in opening 800-3a and coupled at opening 800-3a to valve 800-5a, with a freezable liquid 100-2a inside containment device 800-1a; a duct 800-10a with one end 800-10c coupled to valve 800-9a and a part of duct 800-10a passing through opening 800-8a into the interior of containment 800-1a device, duct 800-10a having a plurality of openings 800-10b along its length within containment device 800-1a, and; a retainer 800-6a positioned to restrict movement of containment device 800-1a within reactor 100-1a.

Depending on operating pressures, presently preferred materials for reactor 100-1a construction include any substantially rigid and substantially nonpermeable materials such as, but not limited to, steel, plastics, glass, fiberglass, and ceramics. Moreover, reactor material selection must have in view the relationship between yield strength and elasticity modulus, as an incorrectly chosen material may result in reactor failure after only a few cycles. The containment 800-1a device presently preferred is a bag like structure of flexible plastic. The presently preferred drive fluid 100-3a is any common hydraulic fluid, though any fluid capable of transmitting hydraulic force may be used. Depending on ambient external operating temperatures, the presently preferred freezable liquid 100-2a is water with an adjuvant such as salt, alcohol, propylene glycol or common antifreeze. The presently preferred type of filter 800-4a is a disc with a series of penetrating holes in it which are no larger than about 1 mm in diameter, preferably with the disc oriented so that the side of the disc contacting the freezable liquid is vertical, in order to discourage accumulation of ice particles. Filter construction materials may be rigid, or may even be of a material such as foam rubber. The presently preferred retainer 800-6a resembles a grate; it may be made of any material capable of restraining the containment device, though a rigid material is presently preferred.

Operation—FIG. 8B

The manner of operating the cryonucleator of FIGS. 8B and 8A begins by filling containment 800-1a with freezable liquid 100-2a, either through valve 800-9a or through valve 800-5a; but for this purpose it is preferable to use valve 800-5a but leaving valve 800-9a open so as to vent any air from within containment 800-1a. Valves 800-5a and 800-9a are then closed. Retainer 800-6a prevents containment 800-1a from moving to where it could obstruct valve 100-4a. Drive fluid 100-3a is then introduced through valve 100-4a to substantially fill all remaining space within reactor 100-1a; care should be taken during this process to also allow venting of air from reactor 100-1a through valve 100-4a, as air is highly compressible and will reduce device effectiveness. Then seal all openings into reactor 100-1a. The apparatus is then exposed to ambient freezing weather below 32 F. Once the freezepoint of freezable liquid 100-2a is reached, it begins to expand, the force of expansion being transmitted through containment 800-1a to drive fluid 100-3a; energy may be harvested at this point or at any colder temperature within freezable liquid 100-2a, depending on the tensile strength of reactor 100-1a. Reactor fracture is a costly and dangerous event.

To harvest the energy, valve 100-4a is coupled to a work object such as an hydraulically operated electrical generator and opened, allowing pressurized drive fluid 100-3a to operate the work object. Alternatively, the energy may be stored by directing the drive fluid 100-3a to one of the storage systems described in the claims. Since lower temperatures generate more energy, an operator of the device may wish, if anticipating lower temperatures, to inject more adjuvant into freezable liquid 100-2a through valve 800-9a into duct 800-10a and its openings 800-10b; in such case, valve 800-5a should be opened to relieve pressure from the additional fluid, and closed when that operation is complete. Or, having captured and used expansive energy at one temperature, the operator may wish, if expecting lower temperatures, to perform this injection procedure to thaw the frozen part of the freezable liquid 100-2a, in order to capture energy from a lower freezepoint, or may do so in successive injections for this purpose. On each occasion where ice has formed within freezable liquid 100-2a, the operator may remove part of the adjuvant by opening valve 800-5a and draining it off.

If water is used as part of freezable liquid 100-2a, the volume of drive fluid 100-3a in reactor 100-1a at the start of a freeze cycle should be no less than 10 percent of the volume of water used, as that is roughly the amount of expansion experienced by water upon freezing.

Due to the inventor's uncertainty mentioned in the Objects and Advantages section of the Background of the Invention in this application, cryonucleator operation at pressures exceeding about 20,000 psi when temperature is at or below −4 F (−20 C) is uncertain.

The above described cycle is renewed by replacing spent drive fluid 100-3a and, if desired, adjusting relative concentrations of adjuvant and water in freezable liquid 100-2a, using the methods above described.

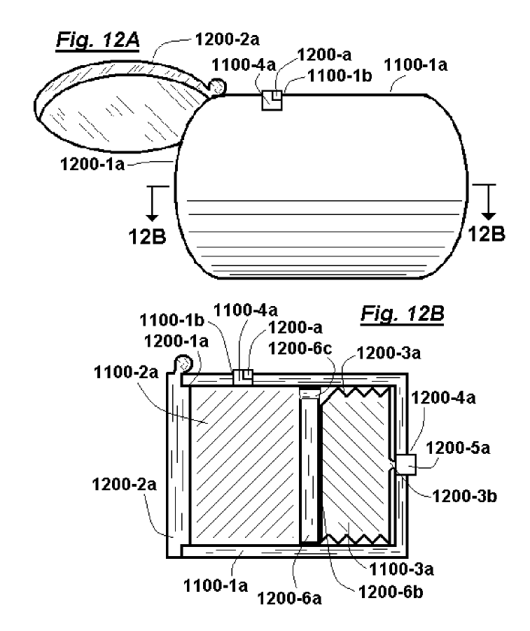

A preferred embodiment of the device of independent claim 11, or cryonucleator using expansion of a freezable liquid, is presented in FIG. 12B, which is a sectional view of FIG. 12A. Shown is reactor 1100-1a, or tank, having a valve 1100-4a seated in reactor opening 1100-1b. Valve 1100-4a enables addition of freezable liquid 1100-2a to reactor 1100-1a, and forms an adaptation 1200-a for purposes discussed below. The opening 1200-1a of reactor 1100-1a provides an exit through which a frozen mass of freezable liquid 1100-2a may be ejected, and that opening can be openably sealed by hatch 1200-2a. Piston 1200-6a, which slidably forms a substantial seal with the inner wall of reactor 1100-1a, is driven by freezing expansion of freezable liquid 1100-2a and forcibly acts against containment device 1200-3a, which in turn forcibly acts upon drive fluid 1100-3a. Valve 1200-5a in opening 1200-4a is coupled to opening 1200-3b of containment device 1200-3a to allow passage of drive fluid 1100-3a between the interior of containment device 1200-3a and a location exterior to reactor 1100-1a. Forcible introduction of drive fluid 1100-3a into containment device 1200-3a causes it to expand and forcibly displace piston 1200-6a in a direction to expel a frozen mass of freezable liquid 1100-2a through opening 1200-1a when hatch 1200-2a is open or removed. Attachment 1200-6b of piston 1200-6a to containment device 1200-3a prevents piston 1200-6a from being removed from within reactor 1100-1a by gravity when reactor 1100-1a is tilted to facilitate ejection of a frozen mass of freezable liquid 1100-2a, or when the frozen mass of freezable liquid 1100-2a strongly adheres to the surface of piston 1200-6a during ejection and could otherwise carry piston 1200-6a with it. Opening 1200-6c of piston 1200-6a helps to eliminate any buildup of freezable liquid 1100-2a on the side of piston 1200-6a where containment device 1200-3a is located by enabling containment device 1200-3a, when a quantity of drive fluid 1100-3a is forcibly introduced into it, to force the buildup to the other side of piston 1200-6a. The pressure relief adaptation 1200-a of valve 1100-4a enables venting of air during addition of freezable liquid 1100-2a to reactor 1100-1a and also facilitates the ejection process by furnishing air to the interior of reactor 1100-1a to prevent formation of a partial vacuum.

Presently preferred materials for construction of reactor 1100-1a, drive fluid 1100-3a, and containment device 1200-3a are as already stated for their equivalent elements in the preferred embodiment of claim 1. If any part of freezable liquid 1100-2a is to be released into the open environment, the preferred freezable liquid is plain water; otherwise, it may be as stated in its equivalent element in the preferred embodiment of claim 1. The presently preferred construction material for piston 1200-6a is a substantially rigid polymer having low friction and adhesion values on its surface, and a low coefficient of thermal expansion. Presently preferred construction material for hatch 1200-2a is principally of metal with seals appropriate to operating temperature and pressure.

Operation—FIG. 12B

The manner of operating the cryonucleator of FIGS. 12B and 12A begins by securing hatch 1200-2a closed and, through valve 1100-4a, introducing a quantity of freezable liquid 1100-2a into reactor 1100-1a, on the side of piston 1200-6a where hatch 1200-2a is located, up to a level just below opening 1200-6c of piston 1200-6a, then forcibly introducing drive fluid 1100-3a into containment device 1200-3a until it substantially occupies all available space within reactor 1100-1a on the side of piston 1200-6a where containment device 1200-3a is located, then adding more freezable liquid 1100-2a until that region of reactor 1100-1a is filled, taking care to vent any air within reactor 1100-1a through relief adaptation 1200-a of valve 1100-4a, as the presence of highly compressible air will reduce device effectiveness. Ideally, if water is used as part or all of the freezable liquid 1100-2a, the volume of drive fluid 1100-3a present at the start of a freeze cycle should be no less than about 10 percent of the volume of the water, as that is roughly the amount of expansion experienced by water upon freezing.

The operator should then seal all openings into reactor 1100-1a, and the apparatus is then exposed to ambient weather capable of causing at least a part of freezable liquid 1100-2a to freeze. Once the freezepoint of that part is reached, it begins to expand, the force of expansion being transmitted through piston 1200-6a to containment device 1200-3a and into drive fluid 1100-3a.

Energy may be harvested at this point or at any colder temperature within freezable liquid 1100-2a, depending on the tensile strength of reactor 1100-1a. Reactor fracture is a costly and dangerous event.

To harvest the energy, valve 1100-4a is coupled to a work object such as an hydraulically operated electrical generator and opened, allowing pressurized drive fluid 100-3a to operate the work object. Alternatively, the energy may be stored by directing the drive fluid 1100-3a to one of the storage systems described in the claims.

After harvesting the energy, water or another liquid is forcibly introduced through valve 1100-4a, drive fluid 1100-3a is forcibly introduced into containment device 1200-3a, hatch 1200-2a is opened, relief adaptation 1200-a of valve 1100-4a is opened and, if needed, reactor 1100-1a is tilted, all to facilitate ejection or removal by hand or mechanized process of the frozen mass of freezable liquid 1100-2a.

Renewal of the above cycle is had by repeating the foregoing steps, except that replenishment of freezable liquid 1100-2a may proceed to a level above opening 1200-6c of piston 1200-6a in order to force piston 1200-6a against containment device 1200-3a, which action, together with some overflow of freezable liquid 1100-2a through opening 1200-6c, will pressurize containment device 1200-3a and then valve 1200-5a should be opened to allow some excess drive fluid 1100-3a to exit through valve 1200-5a.

Due to the inventor's uncertainty mentioned in the Objects and Advantages section of the Background of the Invention in this application, cryonucleator operation at pressures exceeding about 20,000 psi when temperature is at or below −4 F (−20 C) is uncertain.

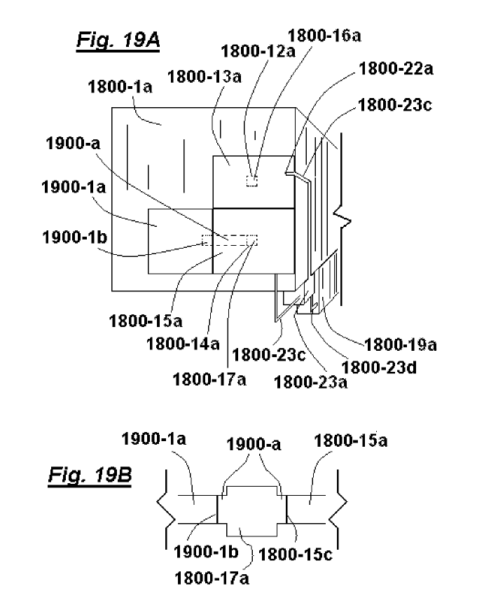

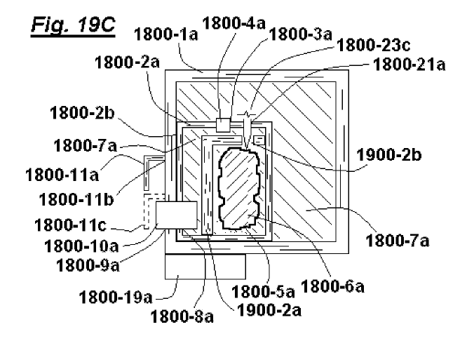

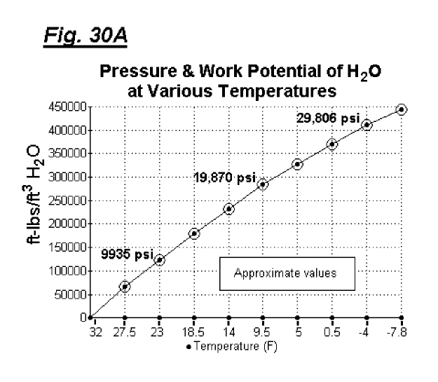

A preferred embodiment of the device of independent claim 18, or extraterrestrial cryonucleator, is presented in part in FIG. 19C, which is a sectional view of FIG. 19A. Reactor 1800-1a, or tank, houses or is attached to a variety of elements, as follows. Freezable liquid 1800-6a fills sealed containment device 1800-5a, which is within retainer 1900-2a along with a sufficient amount of drive fluid 1800-7a to facilitate fluidic communication between the interior of retainer 1900-2a and drive fluid 1800-7a outside of retainer 1900-2a. Retainer 1900-2a serves to prevent containment device 1800-5a from contacting and being damaged by heat exchanger 1800-10a, which is sealably placed through openings 1800-8a and 1800-9a. Sealably surrounding containment device 1800-5a is enclosure 1800-2a, which has valve 1800-4a in its wall through opening 1800-3a. Valve 1800-4a helps to restrict the amount of drive fluid 1800-7a subjected to heat exchange during freeze and thaw processes, making those processes more efficient. Also penetrating enclosure 1800-2a, through opening 1800-21a, is sensor node 1800-23c, which also penetrates near to containment device 1800-5a through adaptation 1900-2b, an opening in retainer 1900-2a. That node detects temperature and pressure of multiple elements. Enclosure 1800-2a has attachment 1800-2b to reactor 1800-1a. To provide fluidic integrity, drive fluid 1800-7a is present throughout the interior of reactor 1800-1a where no other elements are present. Also shown in FIG. 19C are shield 1800-11a attached to reactor 1800-1a at 1800-11b, and controller 1800-19a. Shield 1800-11a is in its open position to permit strong starlight to reach heat exchanger 1800-10a; its alternate position of 1800-11c blocks strong starlight from reaching heat exchanger 1800-10a. Controller 1800-19a, in part using input from sensor 1800-23a (not shown in FIG. 19c) and its nodes, controls the operation of shield 1800-11a and valves in this embodiment.

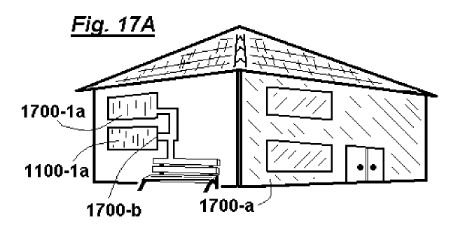

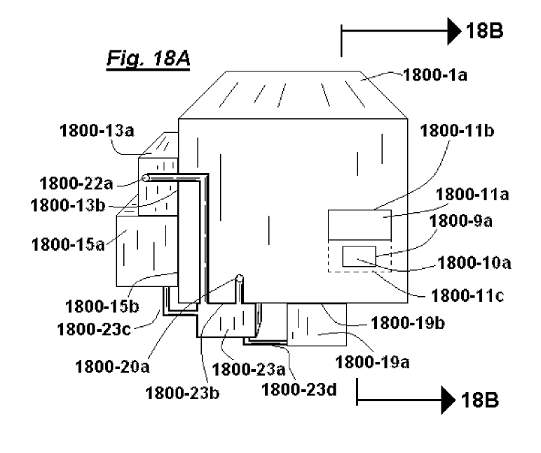

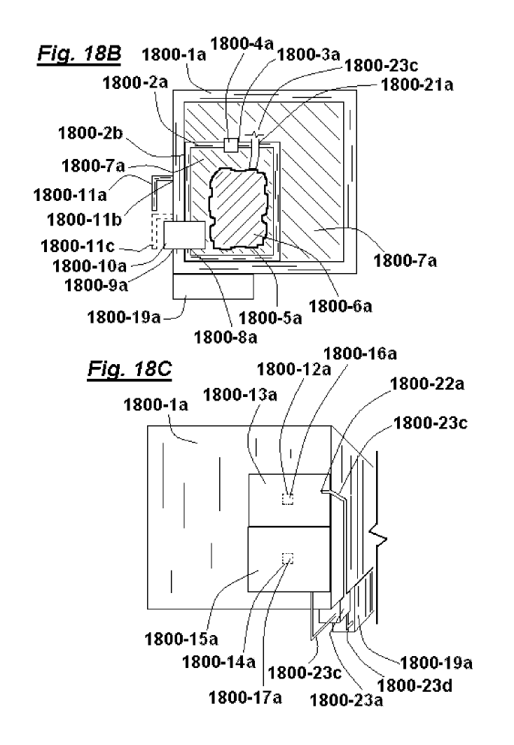

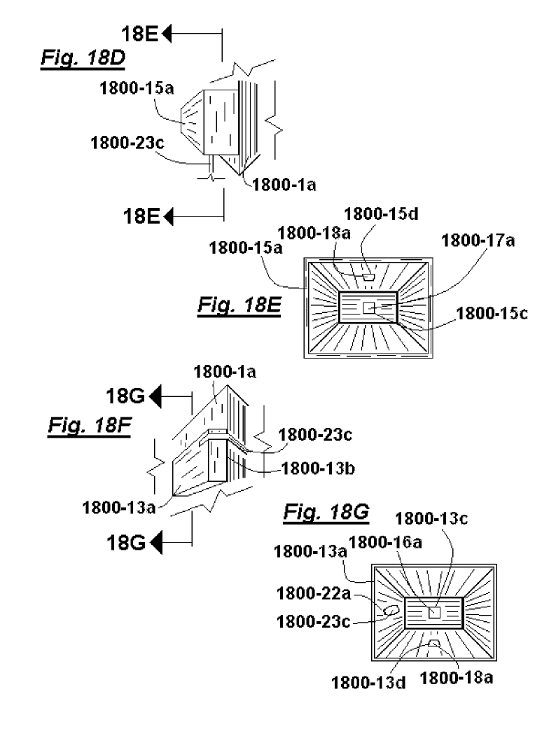

Additional features of the preferred embodiment of the device of independent claim 18 which are not shown at FIG. 19C are shown in FIGS. 19A, 18A, 18E, and 18G, as follows.

FIG. 19A shows a side view of the device of claim 19, with adaptation 1900-a of third valve 1800-17a, an arrangement which allows drive fluid 1800-7a to act upon storage device 1900-1a through opening 1900-1b of storage device 1900-1a; alternatively, adaptation 1900-a may also in this manner permit drive fluid 1800-7a from storage device 1900-1a to operate generator 1800-15a. Valve 1800-17a is seated in opening 1800-14a of reactor 1800-1a. Parts of sensor node 1800-23c and sensor 1800-23a are also shown. Communication 1800-23d of sensor 1800-23a represents communication with controller 1800-19a. Part of sensor 1800-23a enters reservoir 1800-13a through opening 1800-22a. Reservoir 1800-13a, adapted to act as a pump because of low gravity, acts to receive spent drive fluid 1800-7a from generator 1800-15a (additional fluid path shown in later figures) and to return drive fluid 1800-7a into reactor 1800-1a through valve 1800-16a, which is seated, in part, in opening 1800-12a of reservoir 1800-13a (additional fluid path shown in later figures).

FIG. 18A shows shows a side view of the device of claim 19. Elements appearing there and not yet described in detail are included here: attachment 1800-13b of reservoir 1800-13a to reactor reactor 1800-1a; attachment 1800-15b of generator 1800-15a to reactor 1800-1a; opening 1800-20a gives sealed access of a node of sensor 1800-23a into reactor 1800-1a; attachment 1800-23b secures sensor 1800-23a to reactor 1800-1a, and; controller 1800-19a forms attachment 1800-19b with reactor 1800-1a.

FIG. 18E shows a cutaway view of generator 1800-15a, without internal working components. Elements appearing there and not yet described in detail are included here: valve 1800-17a seated in hydraulic fluid intake port 1800-15c of generator 1800-15a, along with valve 1800-18a seated in hydraulic fluid output port 1800-15d of generator 1800-15a.

FIG. 18G shows a cutaway view of reservoir 1800-13a, without internal working components. Elements appearing there and not yet described in detail are included here: opening 1800-13c in which valve 1800-16a is seated, coupling generator intake port 1800-15c to reactor 1800-1a (not shown); opening 1800-13d in which valve 1800-18a is seated, coupling generator output port 1800-15d to reservoir 1800-13a (not shown).

Construction materials and other considerations for elements of the preferred embodiment of claim 18 are substantially the same as for their equivalent elements if and as appearing in the preferred embodiment of claim 1, except as follows. All materials should be able to withstand the rigors of launch and extraterrestrial deployment in its various aspects. The shield device may be an arrangement of blinds or substantially opaque or highly reflective materials, or of a substance having a high degree of infrared absorption. Drive fluid should not be subject to freezing during deployment, should be impeccably free of water or other impurity likely to freeze during deployment, and should not be subject to substantial decomposition due to nonvisible radiation. The elastically deformable element of the storage device should be of a type not likely to be substantially reduced in elasticity due to deployment conditions. Controller and sensors may be of any type consistent with the further limitations of claim 18.

Operation—FIG. 19C, FIGS. 19A, 18A, 18E, and 18G

The manner of operating the cryonucleator of FIG. 19C is as follows. Hydraulic integrity must be maintained during operation; care should be taken to ensure that no air is within the system where drive fluid 1800-7a is expected to be. Water vapor and other freezable vapors, except in freezable liquid 1800-6a, must not be present in the system where any valve or elastically deformable element is present, as this may interfere with system performance. At deployment, drive fluid 1800-7a should fully occupy available space within reactor 1800-1a and fluid compartments of the generator's 1800-15a hydraulic actuator. No drive fluid 1800-7a should be loaded into reservoir 1800-13a, and reservoir 1800-13a capacity should be greater than the volume expansion factor of freezable liquid 1800-6a upon freezing.

At deployment, with all valves closed, shield 1800-11a should should be set to block starlight from heat exchanger 1800-10a until the freezable part of freezable liquid 1800-6a is frozen; an adjuvant may be used in freezable liquid 1800-6a to lower its freezepoint and obtain higher pressures. Two options then present: using valves and their adaptations, direct hydraulic flow only to generator 1800-15a to produce electricity, at the same time permitting flow of spent drive fluid 1800-7a from generator 1800-15a to enter reservoir 1800-13a, or; direct hydraulic flow only to storage device 1900-1a to store energy for later use.

Once expansion of freezable liquid 1800-6a is complete and energy has been harvested as above, valves should be set to: close drive fluid 1800-7a communication between reactor 1800-1a, storage device 1900-1a, and generator 1800-15a, and between reservoir 1800-13a and generator 1800-15a; open drive fluid communication between reactor 1800-1a and reservoir 1800-13a. Then raise shield 1800-11a to expose heat exchanger 1800-10a to strong starlight to melt the frozen part of freezable liquid 1800-6a. At the same time close valve 1800-4a of enclosure 1800-2a to limit the amount of mass needed to be warmed; this step, as freezable liquid 1800-6a thaws, will result in partial vacuum inside enclosure 1800-2a, a condition which will impair heat transfer, the remedy being to intermittently open and close valve 1800-4a once the thawing process is underway in order to reduce the time during which partial vacuums exist, while at once obtaining the benefit of reduced mass for heat exchange. An alternative remedy is discussed later in this application but adds moving parts. Continue the operation until freezable liquid 1800-6a is completely thawed.

The cycle is then renewed by the steps above described.

Due to the inventor's uncertainty mentioned in the Objects and Advantages section of the Background of the Invention in this application, cryonucleator operation at pressures exceeding about 20,000 psi when temperature is at or below −4 F (−20 C) is uncertain.

### Theory of Operation

The operation of the cryonucleator, in terms of its power source, is dependent upon the expansion of a freezable liquid, such as water, as it freezes. Water is roughly reckoned to have about a 10% expansion of its liquid volume upon freezing. The expansion phenomenon is due to changes in hydrogen bonding configurations in the water molecule as water reaches its freezing point.

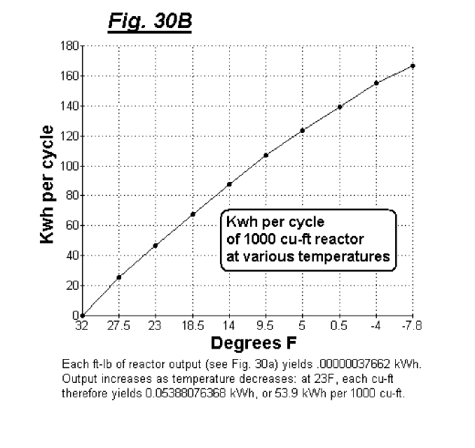

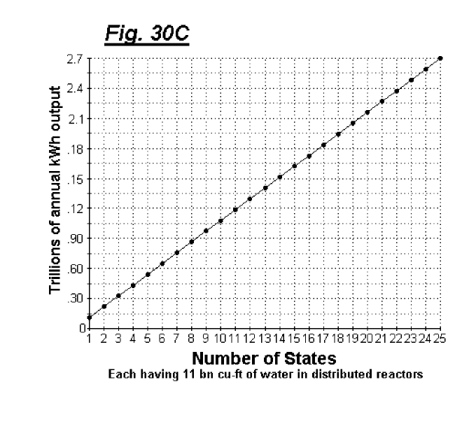

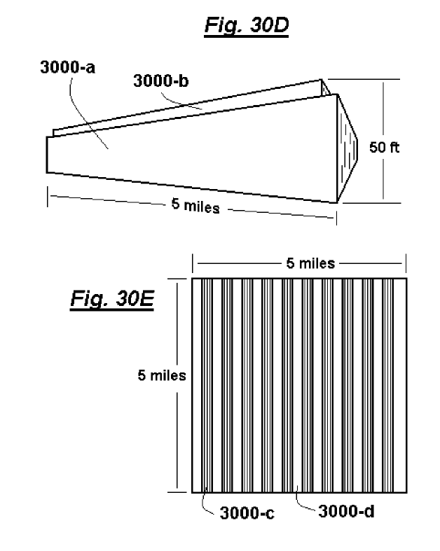

The expansion is driven by great force, and that force increases as temperature decreases, as shown in FIG. 30A. So, within certain limits, the colder it gets, the more energy may be harvested from the freezing and expansion phenomenon.

Therefore, by aid of an elastic storage device or by the expedient of simply preventing expansion until the desired temperature and force have been reached, greater amounts of energy can be harvested.

To the extent that a different view may facilitate explanation of this phenomenon, the expansive force of water converting to ice is commonly rated in terms of the force required to prevent that expansion, rather than in terms of the expansive force per se. That force rises rapidly from about 3700 psi at 27.5 F, to about 20,000 psi at 9.5 F. This force, coupled with the aforementioned 10% expansion factor, yields a tremendous amount of available work to be derived from each cubic foot of water in a cryonucleator. For example, as shown in FIG. 30A, a single cubic foot of water cooled to just below 23 F yields more than 143,000 ft-lbs of safe, renewable energy. This is well within the range of normal environmental temperatures where cold weather occurs.

The use of a freezepoint modifying adjuvant in the freezable liquid of a cryonucleator is an extremely important advancement, since it enables freeze-to-thaw cycling at temperatures below the freezable liquid's normal freezing point, and not only greater power capture within the technical meaning of power, but also greater force in each cycle to increase that power. So, for example, using water with an adjuvant in an amount sufficient to depress the freezing point to, say, 5 F, would enable cycling during times when temperature ranges both above and below that value, e.g., from 12 F to −8 F, and there is greater force in that range than at higher temperatures. In addition, it is known that, upon freezing of water in such a solution, the ice substantially dissociates itself from the adjuvant, and in most cases will rise to the top of the container, thereby enabling an operator to conveniently drain away some adjuvant if higher temperatures are expected.

The extraterrestrial cryonucleator relies upon the principle that areas of interplanetary space which are shaded from solar radiation provide high capacity heat sinks, as there is neither significant atmosphere to resist thermal dissipation nor any significant source of thermal radiation. At the same time there is also the fact that solar radiation in interplanetary space is quite strong and can raise an object's temperature greatly and rapidly. These circumstances result in easy availability of heat sinks and heat sources for highly efficient cryonucleator operation, merely by alternately shading and exposing a heat exchanger for the freezable charge.

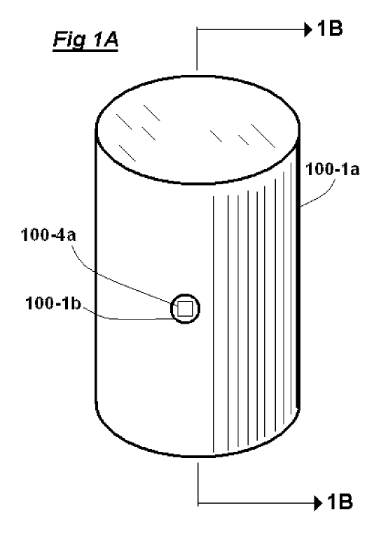

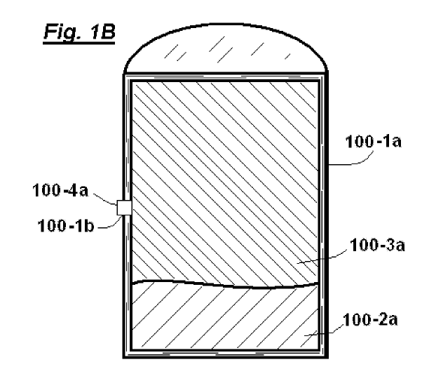

### FIGS. 1A-7B, Inclusive, 9A, 9b, 10A, 11A, 11b, and 13A-18G, Inclusive

### Additional Embodiments

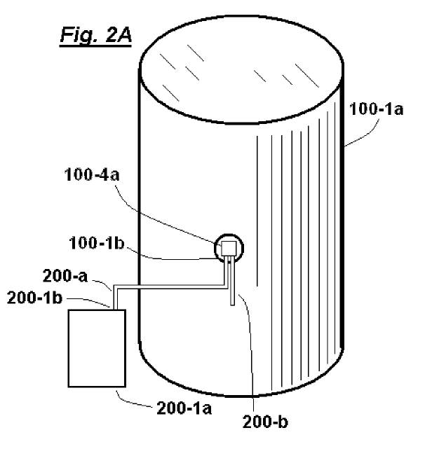

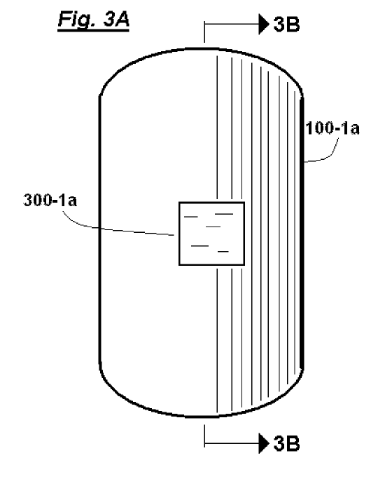

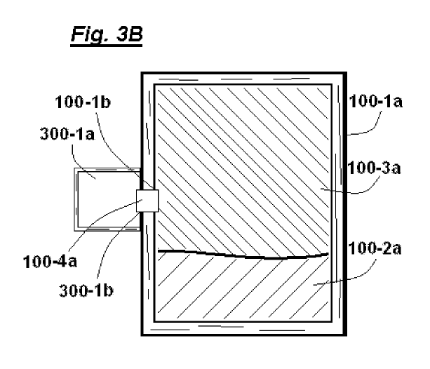

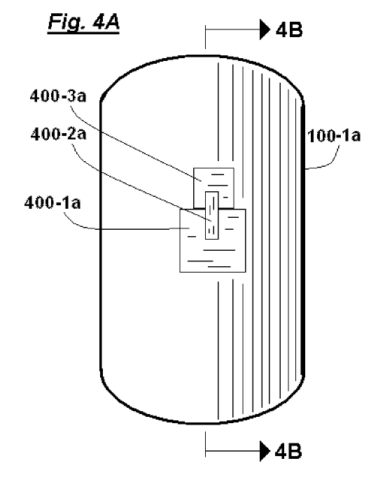

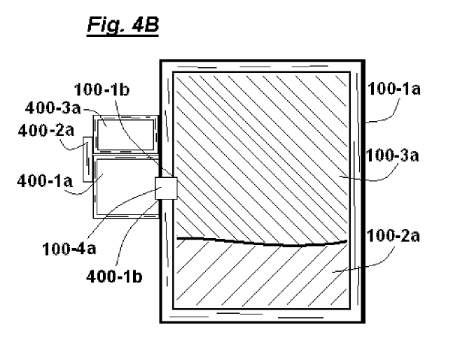

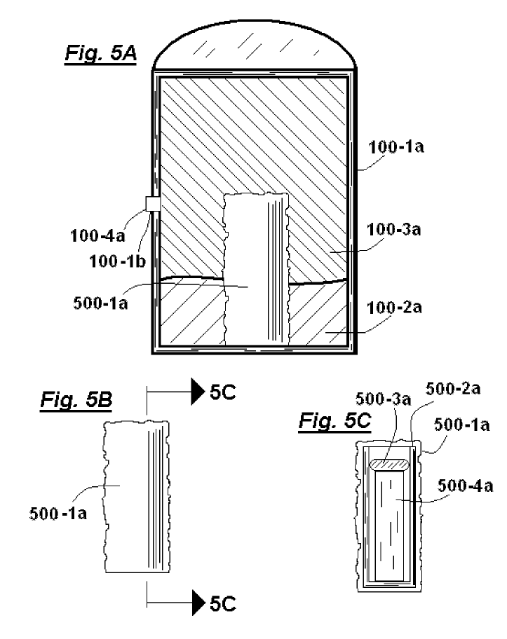

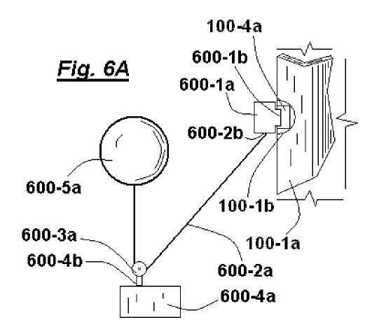

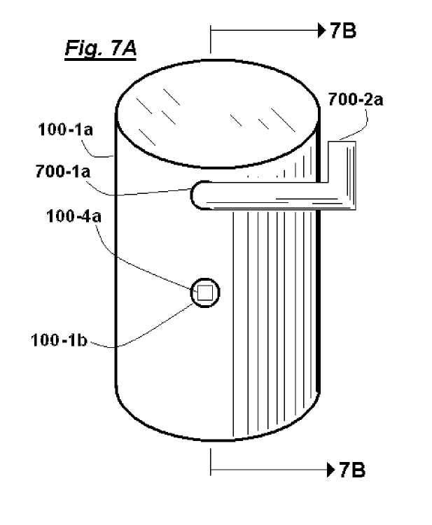

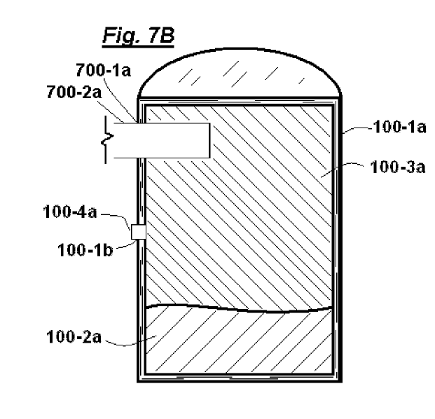

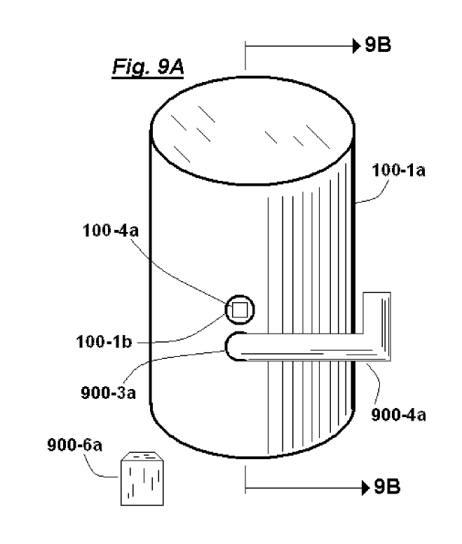

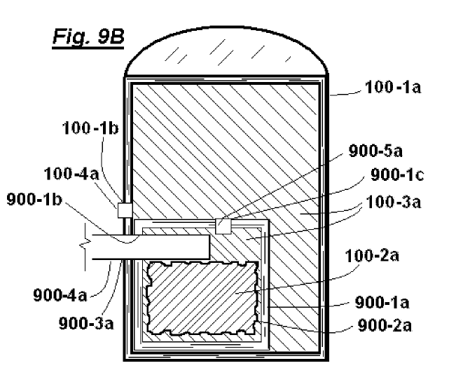

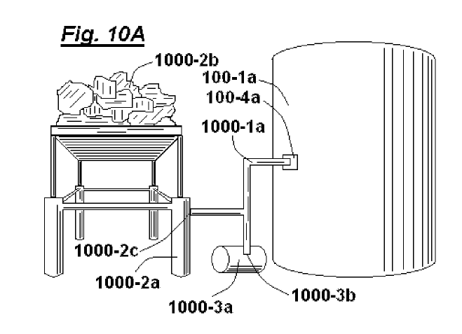

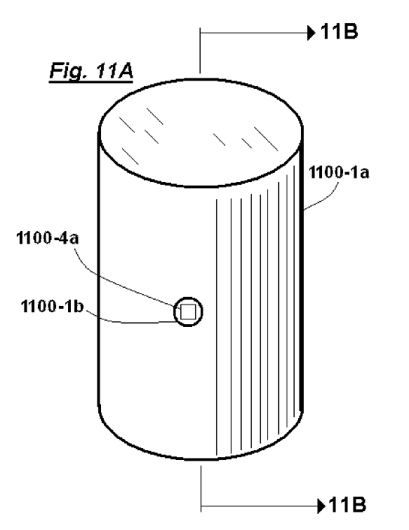

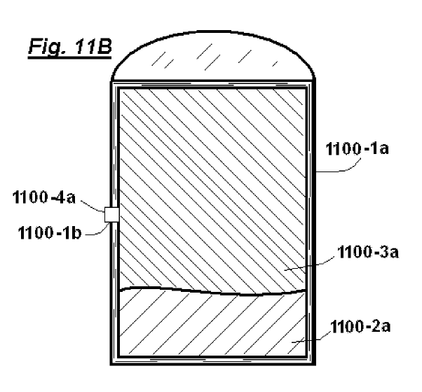

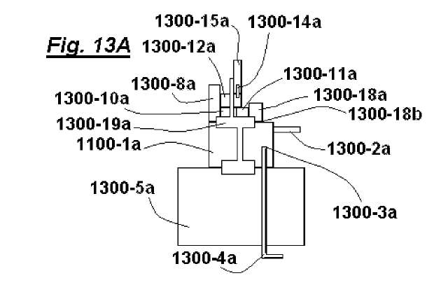

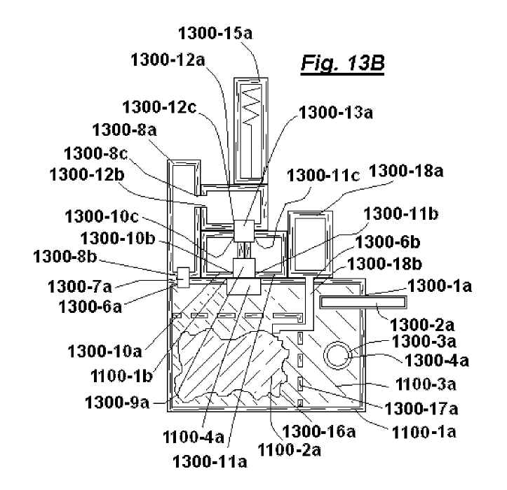

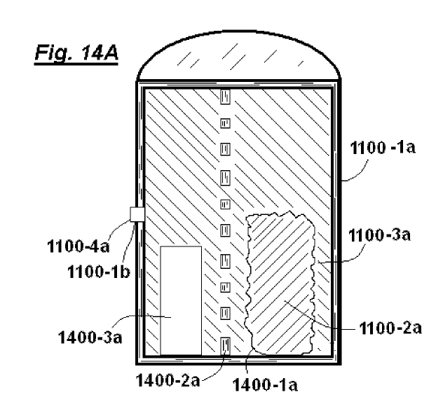

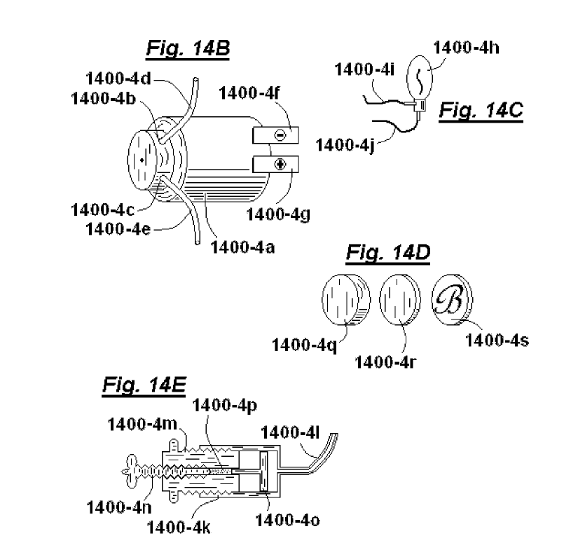

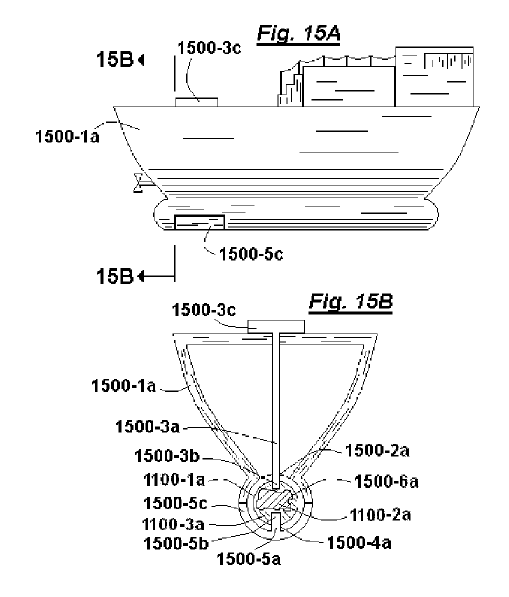

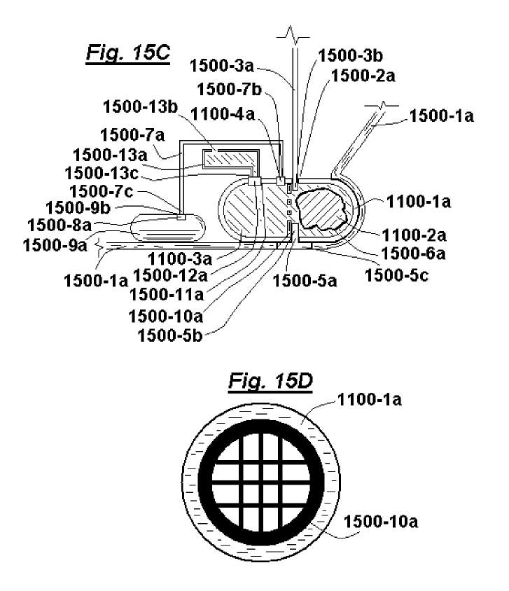

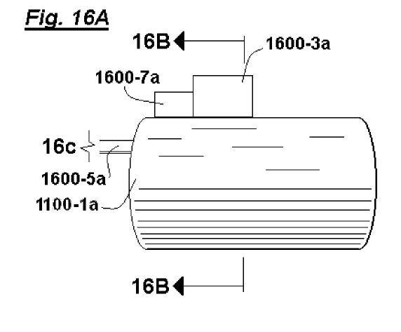

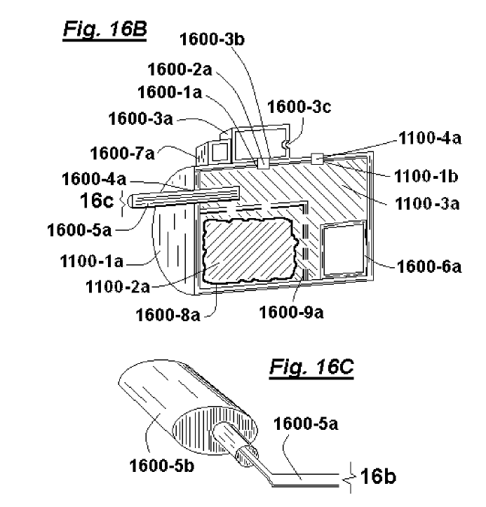

FIGS. 1A and 1B present a simple cryonucleator, with the freezepoint of its freezable liquid below 32 F; FIG. 2A presents a cryonucleator with external energy storage facility in the form of a device incorporating a resilient member; FIGS. 3A and 3B present a cryonucleator with electrical generation facility; FIGS. 4A and 4B present a cryonucleator with electrical generator and water electrolysis facility; FIG. 5A presents a cryonucleator with an internal energy storage facility in the form of a device incorporating a resilient member, cylinder, and piston; FIG. 6A presents a cryonucleator with an external energy storage facility in the form of a float submergeable by an hydraulic winch and pulley; FIGS. 7A and 7B present a cryonucleator with a heat exchanger; FIGS. 9A and 9B present a cryonucleator with a heat exchanger, a controller, an internal container for freezable liquid, and an internal compartment to restrict the amount of mass to be subjected to heat exchange; FIG. 10A presents a cryonucleator with an external energy storage facility in the form of an hydraulic lift raising a load, along with an electrical generator; FIGS. 11A and 11B present a simple cryonucleator with the freezepoint of its freezable liquid at or below 32 F; FIGS. 13A and 13B present a cryonucleator providing power to the electrical generator of a buoy, using dual heat exchangers and dual energy storage facilities; FIGS. 14A-14E present an educational and research desktop size cryonucleator with compression devices and other materials used for education and research; FIGS. 15A-15D present a cryonucleator integral with a ship, or marine conveyance, and includes an energy storage facility; FIGS. 16A-16C present a cryonucleator to supply electrical power to an internal combustion engine; FIG. 17A presents a cryonucleator with heat exchanger integral with a building; FIGS. 18A-18G present a cryonucleator for extraterrestrial use, and includes shield, heat exchanger, reservoir, electrical generator, sensors, controller, and an internal compartment to restrict the amount of mass to be subjected to heat exchange.

### Alternative Embodiments

Many alternative embodiments of the cryonucleator and extraterrestrial cryonucleator are possible. The full scope of possible embodiments should be judged based on the appended claims and their legal equivalents, rather than solely on the accompanying drawings. The alternative embodiments offered here are only by way of example and not limitation.

Thermal sources for induction thawing of the cryonucleator's freezable liquid include, but not by way of limitation, ambient air or earth, solar radiation or radiation from a star, geothermal heat, waste commercial or household heat, liquid water bodies, and fermenting biomass.

As to shapes, many different shapes are possible for all elements of the claims here appended. Tanks or reactors, pistons, storage, and enclosures may be modified to oblong or rectangular or irregular shapes, as the case may be. Such parts could also form part of the wall of a building, or walkway, benches, deck or attractive sculpture.

The arrangement of elements relative to one another or their placement in the environment may be modified. Energy storage devices may be placed outside the reactor rather than within, communicating with drive fluid through a valve; reservoirs may be internalized; various parts of the navigation buoy may be located within the flotation element; a reactor or its heat exchangers may be partly or wholly immersed in a water body to facilitate cycling or ejection; the extraterrestrial cryonucleator may be located on an astrophysical body rather than in space.

The size and proportion of elements relative to one another may be varied, and the overall size of the device of any given claim may be modified.

The addition of certain rudimentary features may also create alternative embodiments. The float submersion embodiment may be modified to transfer force to the float by a means other than winch, cable, and pulley; an hydraulic or direct mechanical linkage might be used. A cryonucleator incorporating a raft and disposed on a water body, similar to the marine conveyance embodiment, is certainly conceivable, and offers the advantage of ready access to a heat source, i.e., the water body itself. This would also offer easy disposal of an ejected frozen charge and ready access to a source of liquid water for a new cycle. Relatedly, the hatch embodiment of claim 12 could be deployed in a water body with the hatch topmost to facilitate ejection, and employing heat exchangers embedded in the reactor walls and extending above and below the surface.

The cryonucleator could also have a plurality of sealed flexible bags within the reactor's drive fluid, each containing a different concentration of an adjuvant in water; thus, power could be generated more steadily across a continuing downward range of subfreezing temperatures.

An alternative embodiment of the extraterrestrial cryonucleator would be one wherein the shield is capable of absorbing and substantially storing thermal energy from incident light, for example, in a liquid, and then pumping that heated liquid into the cryonucleator's heat exchanger to thaw the frozen liquid more quickly, thereby increasing the system's cyclic rate.

The valve seated in the extraterrestrial cryonucleator's containment could be adapted to incorporate a piston which would drive itself deeper into the interior of the containment as the thawing process is underway, thereby maintaining fluid patency for heat exchange, and eliminating the need to intermittently open and close the valve during thawing, although this adds moving parts to the apparatus.

A cryonucleator network with energy storage devices could be used to power a railway system. Such a network would be preferable to having a full cryonucleator in each train, as the latter option would add mass to the train. In a network system, energy would be generated at stations along the route and stored as mechanical energy. Trains would be adapted to operate on hydraulic force and would have one or more cars with hydraulic fluid reservoirs and mechanical energy storage devices, each such storage device incorporating a resilient member and hydraulic fluid. On arrival at station, the station's storage system would fluidically transfer stored energy to the train.

### Advantages

From the foregoing descriptions, many advantages of the present invention are made clear, a few of which are:

[a] abundant, cheap, clean, renewable energy;

[b] reduction of global conflict over energy;

[c] powerful and ongoing economic stimulus;

[d] a powerful desktop research and learning device for the sciences;

[e] reduction in the need for nuclear power aboard spacecraft.

### CONCLUSION, RAMIFICATIONS, AND SCOPE

From the foregoing application, and appended claims and drawings, it is clear that the present invention offers significant resolution to many current problems relating to energy, the environment, economics, and food supply.

As a nation and as part of a global community, it is evident that continuing on our present and dangerous course of daily increasing consumption of carbon based fuels must inevitably result in ever greater catastrophes of every kind and dimension. It is inescapable fact that the very fiber of economic strength relies upon energy and its cheap availability. It is no less clear that this reliance must not be directed to such articles as shall lead to our ultimate destruction.

There is no greater human endeavour than the unification and preservation of humanity and the planet on which it lives. The present invention has the capability to significantly advance that cause.

Descriptions in this application contain many specificities, but these should not be construed as limiting the scope of the invention but as illustrations of its presently preferred embodiments. Therefore, the scope of the invention should be determined by the appended claims and their legal equivalents, rather than by the examples given.

The inventor claims:

1. A device for producing and releasably storing energy, utilizing expansive force of a liquid upon freezing, comprising:
[a] a sealable reactor for containing a pressurized fluid, forming a sealable first opening thereinto;
[b] a freezable liquid, in part containing water, and having a freezing point lower than that of water, disposed within said reactor;
[c] a drive fluid in liquid condition disposed within said reactor in a location where it may remain substantially unmixed with said freezable liquid, and;
[d] a first valve means for regulating fluid flow, sealably disposed in said first sealable opening of said reactor, further disposed such that when the interior of said reactor is pressurized by freezing of said freezable liquid said drive fluid may be substantially the only fluid discharged past said valve means and may be directed to provide motive force to an hydraulically operated work object.

2. The device of claim 1, wherein said first valve means forms a sealable first and second branch, adapted such that said first valve means may permit fluidic communication between any combination of said reactor, an object coupled to said first branch, and an object coupled to said second branch, and further comprising:
[a] at least one storage means for releasably storing mechanical energy, selected from the group of storage means consisting of those using at least one elastically deformable element to store mechanical energy, said storage means forming an opening sealably coupled to said first branch of said adaptation such that expansive force transmitted to said drive fluid by said freezable liquid may be proximally transmitted by said drive fluid to said elastically deformable element to cause the storage of mechanical energy in said storage means, and such that said deformable element may forcibly expel at least a part of said drive fluid from within said storage means.

3. The device of claim 1, further comprising:
[a] a generator means for producing electricity, selected from the group of traditional electrical generators adapted to operate on input of hydraulic force, the fluid intake port thereof sealably coupled to said first valve means such that it may enable said drive fluid to operate said generator means.

4. The device of claim 1, further comprising:
[a] a generator means for producing electricity, selected from the group of traditional electrical generators adapted to operate on input of hydraulic force, the fluid intake port thereof sealably coupled to said first valve means such that it may enable said drive fluid to operate said generator means;
[b] an electrical conduit means for conducting electrical energy generated by said generator means, a part thereof coupled to the electrical output terminals of said generator means, and;
[c] a water electrolysis means for electrolyzing water into its components, coupled to a part of said electrical conduit means such that said electrolysis means may electrolyze water.

5. The device of claim 1, further comprising:
[a] a flexible, sealable container, disposed within said reactor such that it may be in at least partial contact with said drive-fluid;
[b] a rigid cylinder, closed at one end, sealably disposed within said bag such that the open end thereof is proximal to the point of said partial contact with said drive-fluid;
[c] a piston, disposed within said cylinder, substantially, further slidably, forming a seal with the interior wall of said cylinder, such that hydraulic force applied to said container by said drive-fluid may cause force to be exerted upon said piston, and;
[d] at least one resilient member means, selected from the group of such means consisting of springs and gas containers and which are self locking and responsive to remote control for unlocking purposes, disposed within said cylinder such that said piston, when receiving force through said bag, may forcefully impinge upon said resilient member means, causing it to elastically deform.

6. The device of claim 1, further comprising a device for storing mechanical energy produced by the device of claim 1, further comprising:
[a] a releasably self locking hydraulic winch means for exerting force against a load, the fluid intake port thereof sealably coupled to said first valve means;
[b] a cable, forming an attachment at its proximal end with said winch such that on operation of said winch it may experience forcible reduction in its free length;
[c] a pulley, rotatably engaging a part of the free length of said cable;
[d] an anchor means for substantially maintaining said pulley at a desired depth in a body of liquid, forming an attachment with said pulley, and;
[e] a float, coupled to a part of said cable such that when said winch means is operated it may cause said float to submerge, thereby storing said mechanical energy.

7. The device of claim 1, further comprising:
[a] a sealable second opening into said reactor, and;
[b] a heat exchange means for transferring heat between said freezable liquid and heat sinks and heat sources, a part thereof sealably disposed through said second sealable opening of said reactor such that it may facilitate heat transfer affecting said freezable liquid, a part thereof disposed external to said reactor.

8. The device of claim 1, wherein said freezable liquid consists of water and an adjuvant having a depressive effect on the freezing point of water, and wherein said first valve means and said first opening are located topmost in said device, further comprising:
[a] a containment means for sealably containing said freezable liquid, said containment means disposed within said reactor and surrounding said freezable liquid, adapted such that it may permit said freezable liquid to expand upon freezing and transmit the expansive force thereof to a location exterior to said containment means;
[b] a sealable second opening into said reactor;
[c] a sealable first opening into said containment means, disposed proximal to the bottom thereof;
[d] a filter means for substantially separating said water when frozen from said adjuvant when said adjuvant is in a liquid state, securely disposed in said first opening of said containment means such that it may substantially prevent passage of frozen aggregates of said water therethrough while permitting passage therethrough of said liquid adjuvant;
[e] a second valve means for regulating fluid flow, sealably coupled to said second opening of said reactor and sealably coupled to said first opening of said containment means such that an operator using said adjuvant may drain away a part of said adjuvant;
[f] a retainer, disposed within said reactor such that it may maintain said containment means in proximity to said second valve means and prevent said containment means from obstructing said first valve means, while at the same time permitting at least a part of said containment means to contact said drive fluid;
[g] a sealable third opening into said reactor;
[h] a sealable second opening into said containment means;
[i] a third valve means, sealably disposed in said third opening of said reactor, and;
[j] a duct, sealably and securely disposed through said second opening of said containment means, a part thereof extending into said freezable liquid and therein forming a plurality of openings, and forming an opening sealably coupled to said third valve means, such that an operator of the device of this claim may introduce additional adjuvant into said freezable liquid when desired.

9. The device of claim 1, further comprising:
[a] a substantially rigid sealable enclosure, forming sealable first and second openings thereinto, said enclosure disposed within said reactor such that said first sealable opening thereof may permit flow of said drive-fluid therepast;
[b] a containment means for sealably containing said freezable liquid, selected from among the group of containment means consisting of flexible bags, and cylinder and slidable piston configurations having one closed end with said freezable liquid sealed between said piston and said closed end, said containment means disposed within said enclosure, said containment means sealably surrounding said freezable liquid;
[c] a second opening in said reactor;
[d] a heat exchange means for transferring heat between said freezable liquid and heat sinks and heat sources, a part thereof sealably disposed through said second opening of said reactor and sealably through said second opening of said enclosure such that it may facilitate heat transfer affecting said freezable liquid, further such that it may facilitate said heat transfer while minimizing thermal influence from elements outside said enclosure when said enclosure is sealed, a part thereof disposed external to said reactor;
[e] a valve means for regulating flow of said drive fluid therepast, sealably disposed in said first opening of said enclosure, said valve means selected from the group of valve means adapted to be operable from a position exterior to said reactor, and;
[f] a controller means for operating said second valve means, at least a part thereof disposed outside of said reactor, selected from among the group of controller means consisting of those which may be operated by direct mechanical linkage with said second valve means through an additional sealable opening of said reactor, those which may be operated by direct electronic linkage with said second valve means through an additional sealable opening of said reactor, those which may be operated by direct hydraulic linkage with said second valve means through an additional sealable opening of said reactor, and those which may be operated by remote linkage with said second valve means.

10. The device of claim 1, further comprising:
[a] an adapter means for regulating drive fluid flow, sealably coupled to said first valve means, configured such that it may alternately permit flow of said drive fluid to the hydraulic lift means and to the hydraulic generator means as further set forth in this claim 15;
[b] an hydraulic lift means for raising a load, selected from the group of lift means consisting of traditional hydraulic lifts, the fluid intake port thereof sealably coupled to said adapter means such that said drive fluid exiting said reactor may operate said lift means, thereby storing mechanical energy in a load raised by said lift means, and;
[c] a generator means for producing electricity, selected from the group of traditional electrical generators consisting of those with actuators adapted to operate on hydraulic force, the fluid intake port thereof sealably coupled to said adapter means such that said drive fluid exiting said lift means may operate said generator means.

11. A device for producing and releasably storing energy, utilizing displacement characteristics of a freezable liquid upon freezing, wherein said device is integral with and limited to producing and storing said energy for use in a means for performing work selected from the group of such means consisting of a container incorporating a hatch to facilitate ejection of a frozen mass of said freezable liquid, a marine buoy, a desktop sized toy, educational and research apparatus, a marine conveyance, the ignition and electrical system of a combustion engine, and the electrical system of an architectural structure and its appurtenances, comprising:
[a] a sealable reactor for containing a pressurized fluid, forming a first sealable opening thereinto;
[b] a freezable liquid, at least in part containing water, and having a freezing point equal to or lower than that of water, disposed within said reactor;
[c] a drive fluid in liquid condition disposed within said reactor in a location where it may remain substantially unmixed with said freezable liquid, and;
[d] a first valve means for regulating fluid flow, sealably disposed in said first sealable opening of said reactor, further disposed such that when the interior of said reactor is pressurized by freezing of said freezable liquid said drive fluid may be substantially the only fluid discharged past said valve means and may be directed to provide motive force to an hydraulically operated work object.

12. The device of claim 11, wherein said device is adapted to facilitate ejection of a frozen mass of said freezable liquid, and wherein said first valve means forms a pressure relief adaptation adapted to prevent ice from blocking its operation, further comprising:
[a] a sealable second opening into said reactor;
[b] a hatch means for sealably closing said second opening, adapted and disposed such that it may sealably engage said second opening and such that it may, when open, permit passage of a frozen mass of said freezable liquid through said first opening when desired by an operator thereof;
[c] a flexible containment means for containing a fluid, forming a sealable opening thereinto, disposed within said reactor and sealably surrounding said drive fluid;
[d] a sealable third opening into said reactor;
[e] a second valve means for regulating fluid flow, sealably disposed in said third opening of said reactor and sealably coupled to said opening of said containment means, and;
[f] a piston, slidably and substantially sealably conforming to the interior wall of said reactor, forming an attachment with said containment means, further forming an opening therethrough proximal to its interface with said wall such that forcible expansion of said containment means may force at least a part of said freezable liquid through said opening whenever a part of said freezable liquid is present on the side of said piston where said containment means is located.

13. The device of claim 11, further comprising a buoy, further comprising:
[a] a sealable second opening into said reactor;
[b] a first heat exchange means for transferring heat between said freezable liquid and heat sinks, selected from the group of traditional heat exchange means consisting of those whose heat exchange function may be substantially interrupted by an operator, a part thereof sealably disposed through said second sealable opening of said reactor into the interior of said reactor such that it may facilitate heat transfer affecting said freezable liquid, a part thereof disposed external to said reactor;
[c] a sealable third opening into said reactor, and;
[d] a second heat exchange means for transferring heat between said freezable liquid and heat sources, selected from the group of heat exchange means consisting of those whose heat exchange function may be substantially interrupted by an operator, a part thereof sealably disposed through said third sealable opening into the interior of said reactor such that it may facilitate heat transfer affecting said freezable liquid, a part thereof disposed in a location external to said reactor;
[e] a support means for positioning said buoy in a desired location relative to the surface of any water body in which it is disposed, selected from the group of such means consisting of floats, stands forming contact with solid earth, and motorized platforms;
[f] a sealable fourth and fifth opening into said reactor;
[g] a second valve means for regulating flow of said drive fluid, sealably disposed in said fourth opening of said reactor;
[h] a reservoir means for releasably retaining a part of said drive fluid, forming a first and second opening, said first opening thereof sealably coupled to said second valve means, said reservoir means disposed and adapted such that drive fluid may flow between said reservoir and said reactor;
[i] a valve adapter means for directing fluid flow from a valve, sealably coupled to said first valve means and adapted such that it may alternately direct flow of drive fluid from said reactor to one of two destinations;
[j] a first storage means for releasably storing mechanical energy, selected from the group of storage means consisting of those using at least one elastically deformable element to store mechanical energy, said first storage means forming a first and second sealable opening, said first sealable opening thereof sealably coupled to a part of said valve adapter, such that expansive force transmitted to said drive fluid by said freezable liquid may be proximally transmitted by said drive fluid to said elastically deformable element to cause the storage of mechanical energy therein;
[k] a second storage means for releasably storing mechanical energy, selected from the group of storage means consisting of those using at least one elastically deformable element to store mechanical energy, said second storage means forming a first and second sealable opening, said first sealable opening thereof sealably coupled to a part of said valve adapter, such that expansive force transmitted to said drive fluid by said freezable liquid may be proximally transmitted by said drive fluid to said elastically deformable element to cause the storage of mechanical energy therein;
[l] a generator means for producing electricity, selected from the group of generators consisting of those with actuators adapted to operate on hydraulic force, having an hydraulic fluid output port and an hydraulic fluid intake port, said fluid output port thereof sealably coupled to said second opening of said reservoir means;
[m] a third valve means for regulating flow of said drive fluid, forming an adaptation such that it may alternately receive said flow of drive fluid from each of said storage means, a part thereof sealably coupled to said fluid intake port of said generator means, a part thereof sealably coupled to said second sealable opening of said first storage means, and a part thereof sealably coupled to said second sealable opening of said second storage means, such that it may alternately conduct drive fluid from each of said storage means to said generator means;
[n] an electrical conduit for conducting electrical energy generated by said generator means, a part thereof coupled to said generator means such that it may conduct electical current from said generator means to another point;
[o] a beacon means for generating a signal, selected from the group of said means consisting of those generating a visible signal, a non visible signal, an audible sound signal, and an inaudible sound signal, coupled to a part of said electrical conduit such that it may receive electrical current from said generator means and thereby produce said signal;
[p] a containment means for sealably containing said freezable liquid, selected from among the group of containment means consisting of deformable containers, and cylinder and slidable piston configurations having one closed end with said freezable liquid sealed between said piston and said closed end, said containment means sealably surrounding said freezable liquid;
[q] a retainer, disposed within said reactor such that it may prevent said containment means from obstructing any valves of this claim, said retainer adapted such that said drive fluid may contact said containment means;
[r] a controller means for controlling all valves and heat exchange through both of said heat exchange means, adapted such that it may be programmed to do so, selected from among the class of controller means consisting of those capable of forming responsive remote connections with said valves and said heat exchange means, and those capable of forming said connections directly, such that an operator thereof may alternately direct the loading of mechanical energy into said storage means and direct the unloading thereof in order to produce electricity, said controller means further forming a sensor disposed and adapted to detect and report to said controller means the temperature of said freezable liquid, a part of said sensor sealably disposed through said fifth opening of said reactor, and;
[s] at least one attachment means for coupling objects together, disposed such that said attachment means may ensure coupling of such solid parts of this claim as are necessary to maintain substantial cohesion of said parts.

14. The device of claim 11, of size suitable for desktop use, further comprising an educational and research device, further comprising:
[a] a deformable container, disposed within said reactor and sealably surrounding said freezable liquid;
[b] a retainer, disposed within said reactor such that it may prevent said container from obstructing said first valve means;
[c] a storage means for storing mechanical energy received from said drive fluid, selected from the group of such storage means using at least one elastic member to store mechanical energy, disposed within said reactor, and;
[d] a selection of experimental materials and devices, selected from the group of such materials and devices consisting of small hydraulically driven electrical generators with terminals adapted to be coupled to said first valve means and electric lights with terminals adapted to be operated by said generators, hydraulically driven compression devices adapted to be coupled to said first valve means, associated die stamping parts and hardware, including deformable backing discs, and substances and materials capable of being transformed by application of high pressure in ways apparent to a student or researcher.

15. The device of claim 11, further comprising a device integral with and for powering a marine conveyance, further comprising:
[a] a marine conveyance;
[b] a sealable second opening into said reactor;
[c] a first heat exchange means for transferring heat, a part thereof sealably disposed through said second sealable opening of said reactor into the interior of said reactor such that it may facilitate heat transfer affecting said freezable liquid, a part thereof disposed in a location having a temperature within the freezing range of said freezable liquid;
[d] a sealable third opening into said reactor;
[e] a second heat exchange means for transferring heat, a part thereof sealably disposed through said sealable third opening of said reactor into the interior of said reactor such that it may facilitate heat transfer affecting said freezable liquid, a part thereof adapted to be disposed in a location having a temperature within the liquid range of said freezable liquid;
[f] a containment means for sealably containing said freezable liquid, selected from among the group of containment means consisting of deformable containers, and cylinder and slidable piston configurations having one closed end with said freezable liquid sealed between said piston and said closed end, said containment means disposed within said reactor and sealably surrounding said freezable liquid;
[g] a duct having a first and second opening, said first opening thereof sealably coupled to said first valve means of said reactor;
[h] a second valve means for regulating fluid flow, sealably disposed in said second opening of said duct, said second valve means adapted to permit fluidic communication between any combination of said duct and two other destinations;
[i] at least one storage means for releasably storing mechanical energy, selected from the group of storage means consisting of those using at least one elastically deformable element to store mechanical energy, said storage means forming at least one opening thereinto, said opening thereof sealably coupled to said second valve means such that said drive fluid may enter said storage means and cause deformation of said elastically deformable element, and such that said drive fluid, when stored in said storage means may forcibly exit said storage means through said second valve means to perform other useful work, such as but not limited to providing motive force to a propeller shaft or operating an electrical generator;
[j] a retainer means for constraining the position of said containment means, disposed within said reactor, such that it may prevent said containment means from obstructing any valves within said reactor, further adapted and disposed such that said drive fluid may at least partially contact said containment means;
[k] a sealable fourth opening into said reactor;
[l] a third valve means for regulating fluid flow, sealably disposed in said fourth opening of said reactor, and;
[m] a reservoir means for dispensably retaining a part of said drive fluid, forming a first and second opening, said first opening thereof disposed and adapted such that it may receive drive fluid therethrough, said second opening thereof disposed and coupled to said third valve means such that it may permit said drive fluid to enter through said third valve means into said reactor.

16. The device of claim 11, further comprising a device to facilitate starting a combustion engine and to furnish hydraulic power to an hydraulically operated electrical generator, comprising:
[a] a sealable second opening into said reactor;
[b] a second valve means for regulating fluid flow, sealably disposed in said second sealable opening;
[c] a reservoir means for releasably retaining drive fluid to replenish said reactor, forming a first and second sealable opening thereinto, the first said opening thereof sealably coupled to said second valve means, the second opening thereof adapted to form a sealable coupling with the fluid output port of said generator;
[d] a sealable third opening into said reactor;
[e] a heat exchange means for transferring heat between said freezable liquid and a heat source, a part thereof sealably disposed through said third opening of said reactor, a part thereof disposed external to said reactor and adapted to be disposed proximal to a heat source generated by said engine, said heat exchange means selected from among the group thereof capable of substantially and alternately permitting and preventing heat exchange upon command of an operator;
[f] a storage means for releasably storing mechanical energy, selected from the group of storage means consisting of those using at least one elastically deformable element to store mechanical energy, disposed within said reactor, such that expansive force transmitted to said drive fluid by said freezable liquid may be proximally transmitted by said drive fluid to said elastically deformable element to cause the storage of mechanical energy therein;
[g] a controller means for controlling all valves of this claim, the electrical output of said generator means of this claim, and heat exchange through said heat exchange means, disposed such that it may do so, selected from among the class of controller means consisting of those capable of forming responsive remote connections with said valves, said generator means, and said heat exchange means, and those capable of forming said connections directly;
[h] a flexible containment means for sealably containing said freezable liquid, sealably surrounding said freezable liquid, said containment means fabricated of material which may maintain its physical integrity at temperature extremes induced in said drive fluid by said heat exchange means, and;
[i] a retainer means for constraining the position of said containment means, disposed within said reactor, such that it may prevent said containment means from obstructing any valves within said reactor, and such that it may prevent said containment means from reaching any position which may cause it damage from said heat exchange means, said retainer means further adapted and disposed such that said drive fluid may at least partially contact said containment means.

17. The device of claim 11, wherein at least a part thereof is integral with an architectural structure and its appurtenances, and wherein said reactor forms a sealable second opening, further comprising:
[a] at least one heat exchange means for transferring heat, one end thereof sealably disposed through said sealable second opening into said reactor, and one end thereof disposed such that it may transfer heat between the interior of said reactor and a location outside of said reactor.

18. A device for producing and releasably storing energy in an extraterrestrial environment, utilizing displacement characteristics of a freezable medium upon freezing, said device having in all elements thereof the capability of meeting aerospace application requirements of functional integrity when subjected to the rigors of launch and during exposure to extraterrestrial environments where it is deployed, and wherein said device is adapted to be operable from a position external to itself, comprising:
[a] a sealable reactor for containing a pressurized fluid;
[b] a substantially rigid sealable enclosure, said enclosure disposed within said reactor and forming at least one attachment therewith;
[c] a sealable first opening into said enclosure;
[d] a first valve means for regulating flow of said drive-fluid therepast, sealably disposed in said first opening of said enclosure;
[e] a containment means for sealably containing a freezable liquid later recited in this claim, said containment means disposed within said enclosure, said containment means adapted such that it may permit said freezable liquid to expand upon freezing and transmit the expansive force thereof to a location exterior to said containment means;
[f] a freezable liquid, at least in part containing water, which may respond to freezing by significantly expanding, sealably disposed within said containment means;
[c] a drive fluid in liquid condition disposed within said reactor, a part of said drive fluid disposed within said reactor in the region external to said enclosure in a quantity such that no substantial space remains unoccupied within said reactor after all elements specified to be within said reactor are in place, and a part of said drive fluid disposed within said enclosure external to said containment means such that no substantial space remains unoccupied within said enclosure after all elements specified to be within said enclosure are in place, and a part of said drive fluid disposed within a reservoir means later recited in this claim, and a part of said drive fluid disposed within the chambers of an hydraulic generator means recited later in this claim, where fluid within said generator means would normally occur during generator operation;
[h] a sealable second opening into said enclosure;
[i] a sealable first opening into said reactor;
[j] a heat exchange means for transferring heat, a part of said heat exchange means sealably disposed through said first opening of said reactor and a part thereof sealably disposed through said second opening of said enclosure, such that it may facilitate heat transfer affecting said freezable liquid, and a part thereof disposed in a position external to said reactor;
[k] a shield means for regulating the amount of radiant starlight energy reaching said heat exchange means, forming at least one attachment with said reactor, further disposed and adapted such that it may regulate radiant energy reaching said part of said heat exchange means disposed external to said reactor;
[l] a sealable second opening into said reactor;
[m] a reservoir means for releasably retaining at least a part of said drive fluid, forming at least one attachment with said reactor, said reservoir means forming a sealable first and second opening thereinto, said reservoir means selected from the group of reservoir means consisting of those which may forcibly expel fluid therefrom, said first opening of said reservoir means sealably coupled to said second opening of said reactor;
[n] a sealable third opening into said reactor;
[o] an hydraulic generator means for producing electricity, selected from the group of generators consisting of those adapted to operate on hydraulic force, said generator means forming at least one attachment with said reactor, having an hydraulic intake port and an hydraulic output port, said output port sealably coupled to said second opening of said reservoir means;
[p] a second valve means, sealably disposed in said first opening of said reservoir means and in said second opening of said reactor such that it may regulate flow of drive fluid between said reactor and said reservoir means;
[q] a third valve means, sealably disposed in said third opening of said reactor and in said intake port of said generator means, disposed and adapted such that it may regulate flow of drive fluid between said reactor and said generator means;
[r] a fourth valve means, sealably disposed in said output port of said generator means and in said second opening of said reservoir means such that it may regulate flow of drive fluid between said generator means and said reservoir means;
[s] a controller means for controlling positions of all said valve means, the position of said shield means, selected from among the group of controller means consisting of those which may operate by direct coupling to said elements and those which may operate without direct coupling to said elements, adapted and disposed such that it may control said positions, further adapted to respond to programmed instructions for controlling said positions based upon data provided to it by a sensor means later recited herein, further adapted such that it may receive said data from said sensor means, said controller means forming at least one attachment with said reactor;
[t] a sealable fourth opening into said reactor;
[u] a sealable third opening into said enclosure;
[v] a sealable third opening into said reservoir means, and;
[w] a sensor means for detecting and reporting to said controller means, respectively, ambient temperature outside of said reactor, pressure within said reactor and within said enclosure, positions of each said valve means, position of said shield means, and temperature of said freezable liquid, said sensor means forming an attachment with said reactor, said sensor means forming a plurality of nodes adapted to so detect, said plurality of nodes sealably disposed, respectively, through said fourth opening of said reactor and through said third opening of said enclosure and through said third opening of said reservoir means, further capable of forming a communication with said controller means such that it may transmit said data.

19. The device of claim 18, incorporating a further mechanical energy storage apparatus for releasably storing mechanical energy, further wherein said third valve means forms an adaptation to permit flow of said drive fluid between said third valve means and an object in addition to said intake port of said generator means, such that said third valve means may permit fluidic communication between any combination of said object, said generator means, and said reactor, further comprising:
[a] a storage means for releasably storing mechanical energy, selected from the group of storage means consisting of those using at least one elastically deformable element to store mechanical energy, said storage means forming an opening sealably coupled to said adaptation such that expansive force transmitted to said drive fluid by said freezable liquid may be proximally transmitted by said drive fluid to said elastically deformable element to cause the storage of mechanical energy in said storage means, and such that said deformable element may forcibly expel at least a part of said drive fluid from within said storage means, and;
[b] a retainer means for constraining the position of said containment means, disposed within said reactor, such that it may prevent said containment means from obstructing any valves within said reactor, and such that it may prevent said containment means from reaching any position which may cause it damage from said heat exchange means, said retainer means further disposed and forming an adaptation such that said drive fluid may at least partially contact said containment means.
